(19) United States
(12) Patent Application Publication
(10) Pub. No.: US 2022/0074849 A1
(43) Pub. Date: Mar. 10, 2022

(54) SPECTROMETER USING MULTIPLE LIGHT SOURCES

(71) Applicants: THE WAVE TALK, INC., Yuseong-gu Daejeon (KR); KOREA ADVANCED INSTITUTE OF SCIENCE AND TECHNOLOGY, Yuseong-gu Daejeon (KR)

(72) Inventors: Yongkeun PARK, Daejeon (KR); Young Dug KIM, Gyeonggi-do (KR); Hyeongkyu DO, Daejeon (KR)

(21) Appl. No.: 17/464,360

(22) Filed: Sep. 1, 2021

(30) Foreign Application Priority Data
Sep. 10, 2020 (KR) 10-2020-0115860

(51) Int. Cl. G01N 21/31; G06N 3/08

(52) U.S. Cl. CPC G01N 21/31; G01N 2201/12; G06N 3/08

(57) ABSTRACT

The present disclosure relates to a spectrometer using multiple light sources. The spectrometer includes: a sample unit accommodating the sample; a multiple-light-sources unit irradiating light of different wavelengths to the sample unit; a sensor unit configured to measure absorbance generated at a wavelength of a light source irradiated to the sample unit; and a multiple scatterer configured to amplify the number of multiple scattering of the light source irradiated to the sample unit, wherein the sensor unit derives spectrum information by measuring absorbance at different wavelengths.

### TECHNICAL FIELD

The present disclosure relates to a spectrometer using multiple light sources, and more particularly, to a spectrometer using multiple light sources capable of improving sensitivity by using a multiple-light-sources unit for irradiating different light sources to a sample unit and a multiple scatterer capable of forming a long optical path length.

### BACKGROUND ART

A spectrometer is a device that identifies a substance by analyzing a spectrum emitted from a substance or a spectrum absorbed by a substance, and is used in various industrial fields.

The spectrometer irradiates a light source to a sample through a light source unit that generates light, and analyzes the substance of the sample by analyzing the light source. However, spectrometers of the related art have the following problems.

Spectrometers of the related art irradiate a light source to a sample and analyze the light source to analyze the substance of the sample, and a sensitivity of a system is determined by a sensitivity of a sensor of the spectrometer. Therefore, when the sensitivity of the sensor is low, there is a problem in that it is impossible to measure a trace amount of substance contained in the sample.

When a sensor device capable of precise analysis is used, the sensitivity may be improved, but there is a problem in that the manufacturing cost of a spectrometer including such sensor device is increased.

### DESCRIPTION OF EMBODIMENTS

### Technical Problem

The present disclosure is to solve the above-described problem, and more particularly, relates to a spectrometer using multiple light sources capable of improving sensitivity by using a multiple-light-sources unit for irradiating different light sources to a sample unit and a multiple scatterer capable of forming a long optical path length.

### Solution to Problem

A spectrometer using multiple light sources of the present disclosure to solve the above-described problem includes a sample unit accommodating the sample; a multiple-light-sources unit irradiating light of different wavelengths to the sample unit; a sensor unit configured to measure absorbance generated at a wavelength of a light source irradiated to the sample unit; and a multiple scatterer configured to amplify the number of multiple scattering of the light source irradiated to the sample unit, wherein the sensor unit derives spectrum information by measuring absorbance at different wavelengths.

In a light source irradiated from the multiple-light-sources unit of the spectrometer using multiple light sources of the present disclosure to solve the above-described problem, an optical path length inside the spectrometer is lengthened by the multiple scatterer.

The multiple-light-sources unit of the spectrometer using multiple light sources of the present disclosure to solve the above-described problem sequentially irradiates light of different wavelengths to the sample unit.

The sensor unit of the spectrometer using multiple light sources of the present disclosure to solve the above-described problem derives spectrum information while measuring absorbance occurring at different wavelengths with a single sensor.

The multiple-light-sources unit of the spectrometer using multiple light sources of the present disclosure to solve the above-described problem includes a plurality of optical filters capable of passing different wavelengths.

The sensor unit of the spectrometer using multiple light sources of the present disclosure to solve the above-described problem derives spectrum information by measuring absorbance at different wavelengths sequentially irradiated to the sample unit, and comprises an image sensor obtaining a plurality of images by photographing the spectrum information in time series.

The spectrometer using multiple light sources of the present disclosure to solve the above-described problem further includes a substance information providing device configured to provide information on a substance included in a sample using a plurality of images obtained in the in time series, wherein the substance information providing device includes a receiving unit for receiving the plurality of images; a detecting unit for extracting a feature of a change over time from the plurality of images captured in the in time series; a learning unit for machine learning classification criteria based on the extracted features; and a determining unit for classifying substances included in the sample based on the classification criteria.

The learning unit of the spectrometer using multiple light sources of the present disclosure to solve the above-described problem learns the classification criteria by using a convolution neural network.

The learning unit of the spectrometer using multiple light sources of the present disclosure to solve the above-described problem learns the classification criteria based on a temporal correlation of the plurality of images.

### Advantageous Effects of Disclosure

The present disclosure relates to a spectrometer using multiple light sources capable of improving sensitivity by using a multiple-light-sources unit for irradiating different light sources to a sample unit and a multiple scatterer capable of forming a long optical path length.

The present disclosure improves the sensitivity of a spectrometer by forming the long optical path length using the multiple scatterer. Accordingly, the sensitivity of the spectrometer may be improved without a spectrometer including an expensive sensor, and a trace amount of substance present in the sample may be measured.

### BRIEF DESCRIPTION OF DRAWINGS

FIG. 1 is a diagram illustrating a configuration of a spectrometer using multiple light sources according to an embodiment of the present disclosure.

FIG. 2 is a diagram illustrating a multiple-light-sources unit using an optical filter according to an embodiment of the present disclosure.

FIG. 3 is a diagram illustrating a sensor unit and a substance information providing device according to an embodiment of the present disclosure.

FIG. 4 is a diagram illustrating the configuration of the substance information providing device according to an embodiment of the present disclosure.

FIG. 5 is a diagram illustrating an example of a network environment according to an embodiment of the present disclosure.

FIGS. 6 and 7 are diagrams for explaining a method of analyzing a substance of a sample according to a temporal correlation of a spectrum in a learning unit according to an embodiment of the present disclosure.

### MODE OF DISCLOSURE

The present specification describes the principles of the present disclosure and discloses embodiments so that the scope of the present disclosure may be clarified, and those of ordinary skill in the art to which the present disclosure belongs may implement the present disclosure. The disclosed embodiments may be implemented in various forms.

Expressions such as “include” or “may include” that may be used in various embodiments of the present disclosure indicate the existence of a corresponding function, operation, or component that has been disclosed, and an additional one or more functions, operations, or It does not limit the components, etc. In addition, in various embodiments of the present disclosure, terms such as “include” or “have” are intended to designate the presence of features, numbers, steps, actions, components, parts, or a combination thereof described in the specification, it is to be understood that it does not preclude the possibility of the presence or addition of one or more other features or numbers, steps, actions, components, parts, or combinations thereof.

When a component is referred to as being “connected, coupled” to another component, the component may be directly connected or coupled to the other component, but between the component and the other component. It should be understood that there may be other components new to the device. On the other hand, when a component is referred to as being “directly connected” or “directly coupled” to another component, it should be understood that no new other component exists between the component and the other component.

Terms such as first and second used in the present specification may be used to describe various elements, but the elements should not be limited by the terms. The terms are used only for the purpose of distinguishing one component from another component.

The present disclosure relates to a spectrometer using multiple light sources capable of improving sensitivity by using a multiple-light-sources unit for irradiating different light sources to a sample unit and a multiple scatterer capable of forming a long optical path length. Hereinafter, example embodiments of the present disclosure will be described in detail with reference to the accompanying drawings.

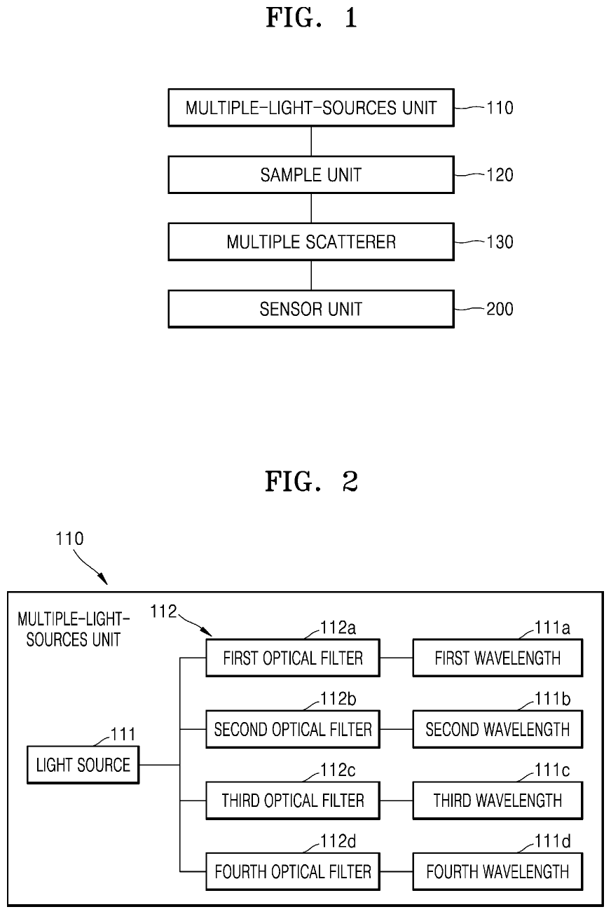

Referring to FIG. 1, a spectrometer using multiple light sources according to an embodiment of the present disclosure includes a multiple-light-sources unit 110, a sample unit 120, a multiple scatterer 130, and a sensor unit 200.

The sample unit 120 is capable of accommodating a sample. The spectrometer according to an embodiment of the present disclosure is capable of detecting a substance in a sample accommodated in the sample unit 120, and various samples may be accommodated in the sample unit 120.

Substances to be detected by the spectrometer according to an example embodiment of the present disclosure may be various substances, may be microorganisms, or substances other than microorganisms. The sample unit 120 may be configured in various ways as long as light may be introduced from the multiple-light-sources unit 110 to be described later while the sample is accommodated.

The multiple-light-sources unit 110 is capable of irradiating light of different wavelengths to the sample unit 120. The multiple-light-sources unit 110 may form light sources having different wavelengths and irradiate the same to the sample unit 120, and the light source irradiated by the multiple-light-sources unit 110 may be various types of light sources.

The multiple-light-sources unit 110 may be variously configured as long as it may form light sources of different wavelengths, and the multiple-light-sources unit 110 may include a plurality of light source units each forming light source of different wavelengths to irradiate light of different wavelengths to the sample unit 120.

In addition, referring to FIG. 2, the multiple-light-sources unit 110 may include a plurality of optical filters 112 passing different wavelengths. When the multiple-light-sources unit 110 includes the plurality of optical filters 112, a plurality of light sources having different wavelengths may be form by a light source 111.

In an embodiment, referring to FIG. 2, when the light source 111 is irradiated to a first optical filter 112a, a second optical filter 112b, a third optical filter 112c, and a fourth optical filter 112d through which different wavelengths pass, a first light source 111a, a second light source 111b, a third light source 111c, and a fourth light source 111d having different wavelengths may be formed. Here, the optical filters 112 have been described as including the first optical filter 112a, the second optical filter 112b, the third optical filter 112c, and the fourth optical filter 112d, but the number of optical filters is not limited thereto and may be changed as necessary.

The sensor unit 200 is capable of measuring an absorbance generated at the wavelength of the light source irradiated to the sample unit 120. The sensor unit 200 may include a sensor measuring absorbance for absorbing a light source from the sample of the sample unit 120.

The sensor unit 200 may measure absorbance at different wavelengths and derive spectrum information based on this, and through this, it is possible to investigate the substance contained in the sample accommodated in the sample unit 120.

The spectrometer using multiple light sources according to an embodiment of the present disclosure may further include the multiple scatterer 130. The multiple scatterer 130 is capable of amplifying the number of multiple scattering of light source irradiated to the sample unit 120.

In the conventional spectrometer, when measuring an absorbance at a wavelength, there is a problem that the sensitivity of the sensor is not high as the optical path length inside the spectrometer is not long.

However, in the spectrometer using multiple light sources according to an embodiment of the present disclosure, the light source irradiated by the multiple-light-sources unit 110 has an optical path length inside the spectrometer increased by the multiple scatterer 130, thereby improving sensitivity of the sensor.

In an embodiment, the multiple scatterer 130 reflects a part of the light source irradiated by the multiple-light-sources unit 110 to amplify the number of multiple scattering, and may include a multiple scattering substance. For example, the multiple scattering substance may include titanium oxide (TiO₂).

The multiple scatterer 130 may be formed in at least a portion of a path through which light sources irradiated by the multiple-light-sources unit 110 pass, and the multiple scatterer 130 may be disposed at various points of the spectrometer as long as the optical path length inside the spectrometer is increased by amplifying the number of multiple scattering of light sources irradiated to the sample unit 120.

As the optical path length inside the spectrometer is lengthened by the multiple scatterer 130, a degree of light absorption in the sample of the sample unit 120 may be maximized, and thus, even when a trace amount of substance is present in the sample, this may be measured by the spectrometer.

It is preferable that the multiple-light-sources unit 110 of the spectrometer using multiple light sources according to an embodiment of the present disclosure sequentially irradiates different wavelengths of light sources to the sample unit 120, and it is preferable that the sensor unit 200 derives spectrum information while measuring absorbance generated at different wavelengths with a single sensor 210.

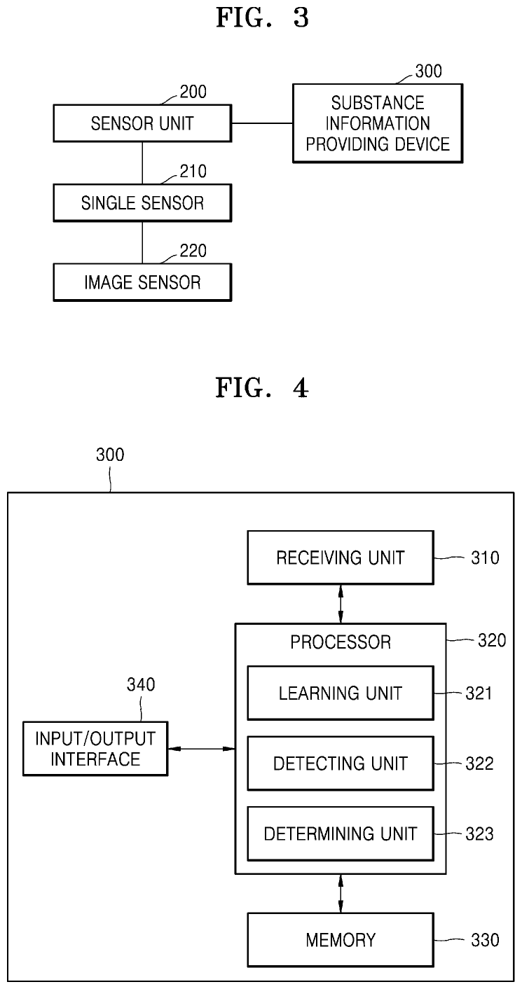

Referring to FIGS. 1 and 3, as the multiple-light-sources unit 110 sequentially irradiates light of different wavelengths to the sample unit 120, and the sensor unit 200 consisting of the single sensor sequentially measures the absorbance, spectrum information may be formed in time series.

That is, as the multiple-light-sources unit 110 irradiates a first light source to the sample unit 120, and the single sensor of the sensor unit 200 measures the absorbance, and the multiple-light-sources unit 110 irradiates a second light source having a different wavelength from that of the first light source to the sample unit 120, and the same single sensor of the sensor unit 200 measures the absorbance, spectrum information may be formed in time series.

The sensor unit 200 of a spectrometer using multiple light sources according to an embodiment of the present disclosure measures absorbance at different wavelengths sequentially irradiated to the sample unit 120 to derive spectrum information, and may include an image sensor 220 photographing the spectrum information in time series and obtaining a plurality of images.

The image sensor 220 may capture spectrum information derived through the sensor unit 200 in time series, and the image sensor 220 may detect spectrum information at a preset time. In an embodiment, the image sensor 220 may detect a first image for a spectrum at a first time, and may detect a second image for a spectrum at a second time.

Here, time means any one moment in the continuous time flow, and the time may be set in advance at regular time intervals, but are not necessarily limited thereto, and may be set in advance at any time intervals. In addition, the first time and the second time are only one example selected for convenience of description, and the image sensor 220 may capture a plurality of images at a plurality of times more than the first time and the second time.

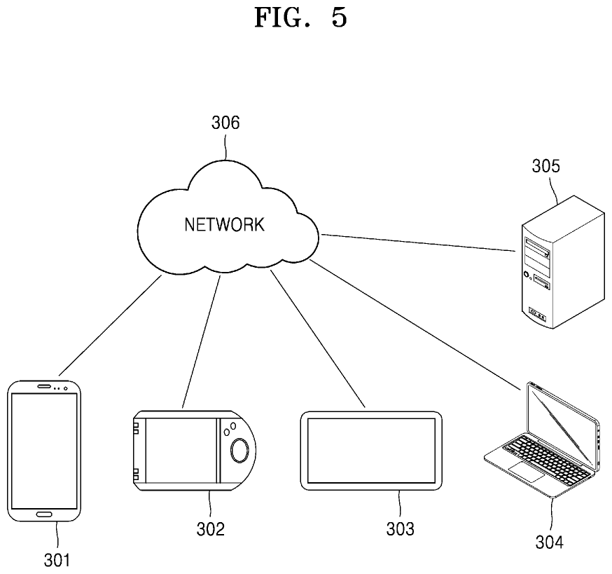

Referring to FIGS. 3 and 4, a spectrometer using multiple light sources according to an embodiment of the present disclosure may further include a substance information providing device 300 providing information on a substance included in a sample using a plurality of images captured in time series.

FIG. 5 is a diagram illustrating an example of a network environment according to an embodiment of the present disclosure. The network environment of FIG. 5 includes a plurality of user terminals 301, 302, 303, and 304, a server 305, and a network 306. Here, the substance information providing device 300 may be a server or a user terminal. This FIG. 5 is an example for explaining the disclosure, and the number of user terminals or the number of servers is not limited as shown in FIG. 5.

The plurality of user terminals 301, 302, 303, and 304 may be a fixed terminal or a mobile terminal implemented as a computer device. When the substance information providing device 300 is the server 305, a plurality of user terminals 301, 302, 303, and 304 may be terminals of an administrator controlling the server. A plurality of user terminals 301, 302, 303, and 304 are, for example, smart phones, mobile phones, navigations, computers, laptops, terminals for digital broadcasting, personal digital assistants (PDAs), portable multimedia players (PMPs), tablet PCs or the like.

For example, a first user terminal 301 may communicate with other user terminals 302, 303, 304 and/or the server 305 through a network 306 using a wireless or wired communication method. In another embodiment, the plurality of user terminals 301, 302, 303, and 304 may include the above-described image sensor 220 and may transmit the obtained plurality of images to the server 305 through the network 306.

The communication method is not limited, and not only a communication method using a communication network that may be included in the network 306 (for example, a mobile communication network, a wired Internet, a wireless Internet, a broadcasting network), but also a short-range wireless communication between devices may be included. For example, the network 306 may include any one or more of networks such as a personal area network (PAN), a local area network (LAN), a capus area network (CAN), a metropolitan area network (MAN), a wide area network (WAN), a metropolitan area network (MAN), a wide area network (WAN), a broadband network (BBN), and the Internet.

In addition, the network 306 may include any one or more of networks such as a bus network, a star network, a ring network, a mesh network, a star-bus network, and a network topology including a tree or a hierarchical network, but it is not limited thereto.

The server 305 may be implemented as a computer device or a plurality of computer devices that communicates through a plurality of user terminals 301, 302, 303, and 304 and a network 306 to provide commands, codes, files, contents, and services.

For example, the server 305 may provide a file for installing an application to the first user terminal 301 accessed through the network 306. In this case, the first user terminal 301 may install the application using the file provided from the server. In addition, the first user terminal 301 may connect to the server 305 under the control of an operating system (OS) and at least one program (for example, a browser or an installed application) to be provided services or contents from the server 305. As another example, the server 305 may establish a communication session for data transmission/reception, and may route data transmission/reception between the plurality of user terminals 301, 302, 303, and 304 through the established communication session.

FIG. 4 is a block diagram of a substance information providing device 300 according to an embodiment of the present disclosure. Referring to FIG. 4, the substance information providing device 300 according to an embodiment of the present disclosure may correspond to at least one processor or may include at least one processor.

Accordingly, the substance information providing device 300 may be driven as being included in a hardware device such as a microprocessor or a general-purpose computer system. Here, for example, the ‘processor’ may refer to a data processing device embedded in hardware having a physically structured circuit for performing a function expressed as a code or command included in a program. As an example of a data processing device built into the hardware as described above, processing devices such as a microprocessor, a central processing unit (CPU), a processor core, a multiprocessor, and an Application-Specific Integrated Circuit (ASIC) and a Field Programmable Gate Array (FPGA) may be included, but the scope of the present disclosure is not limited thereto.

The substance information providing device 300 may be mounted on at least one of the plurality of user terminals 301, 302, 303, and 304, or may be provided on the server 305. As another embodiment, the substance information providing device 300 may be provided on two servers 305. At this time, learning about a microorganism classification criteria to be described later is performed through one server, and the other server can determine a substance based on a learned algorithm.

The substance information providing device 300 illustrated in FIG. 4 shows only the components related to the present embodiment in order to prevent blurring of the features of the present embodiment. Accordingly, it may be understood by those of ordinary skill in the art related to the present embodiment that other general-purpose components may be further included in addition to the components illustrated in FIG. 4.

Referring to FIG. 4, the substance information providing device 300 according to an embodiment of the present disclosure may include a receiving unit 310, a processor 320, a memory 330, and an input/output interface 340. The processor 320 may include a detecting unit 322 extracting features of change over time from a plurality of images captured in time series, a learning unit 321 machine learning classification criteria based on the extracted features, and a determining unit 323 classifying substances included in the sample based on the classification criteria.

The receiving unit 310 may receive a plurality of images obtained in time series by the image sensor 220. In an embodiment, when the substance information providing device 300 is mounted on the user terminal 301, 302, 303 and 340 having the image sensor 220, the receiving unit 310 may be connected to the image sensor 220 by wire and may be provided the captured plurality of images.

In another embodiment, when the substance information providing device 300 is provided in a server 305 provided separately from the image sensor 220, the receiving unit 310 functions as a communication module using wired or wireless communication, and may receive the plurality of images. At this time, the receiving unit 310 may provide a function for communicating between the first user terminal 301 and the server 305 through the network 306, and may provide a function for communicating with another user terminal (for example, a second user terminal 302) or another server (for example, server 305).

For example, a request generated by a processor of the first user terminal 301 according to a program code stored in a recording device such as a memory may be transmitted to the server 305 through the network 306 under the control of the communication module. Conversely, control signals, commands, contents, files, etc. provided according to the control of the processor 320 of the server 305 are transmitted to the first user terminal 301 through the receiving unit 310, the network 306 and the communication module of the first user terminal 301. For example, the control signals or commands of the server 305 received through the communication module may be transmitted to the processor or memory.

The processor 320 may be configured to process commands of a computer program by performing basic arithmetic, logics, and input/output operations. The commands may be provided to the processor 320 by the memory 330 or the receiving unit 310. For example, the processor 320 may be configured to execute a command received according to a program code stored in the recording device such as memory 330. The processor 320 may include a learning unit 321, a detecting unit 322, and a determining unit 323.

The memory 330 is a computer-readable recording medium, and may include a permanent mass storage device such as a random access memory (RAM), read only memory (ROM), and a disk drive. In addition, the memory 330 may store an operating system and at least one program code (for example, a browser installed and driven in the first user terminal 301 or a code for the application).

These software components may be loaded from a computer-readable recording medium separate from the memory 330 using a drive mechanism. Such a separate computer-readable recording medium may include a computer-readable recording medium such as a floppy drive, a disk, a tape, a DVD/CD-ROM drive, or a memory card.

In another embodiment, software components may be loaded into the memory 330 through the receiving unit 310 rather than the computer-readable recording medium. For example, at least one program may be loaded into memory 330 based on programs (for example, the above-described application) installed by developers or files provided by a file distribution system (for example, the above-described server 305) that distributes installation files of the application through the network 306.

The input/output interface 340 may be a means for an interface with an input/output device. For example, an input device may include devices such as a keyboard or a mouse, and an output device may include a device such as a display for displaying the communication session of the application. As another example, the input/output interface 340 may be a means for interfacing with a device in which input and output functions are integrated into one, such as a touch screen. As a more specific example, when the processor 320 of the server 305 processes commands of the computer program loaded in the memory 330, the service screen or contents configured by using data provided by the second user terminal 302 may be displayed on the display through the input/output interface 340.

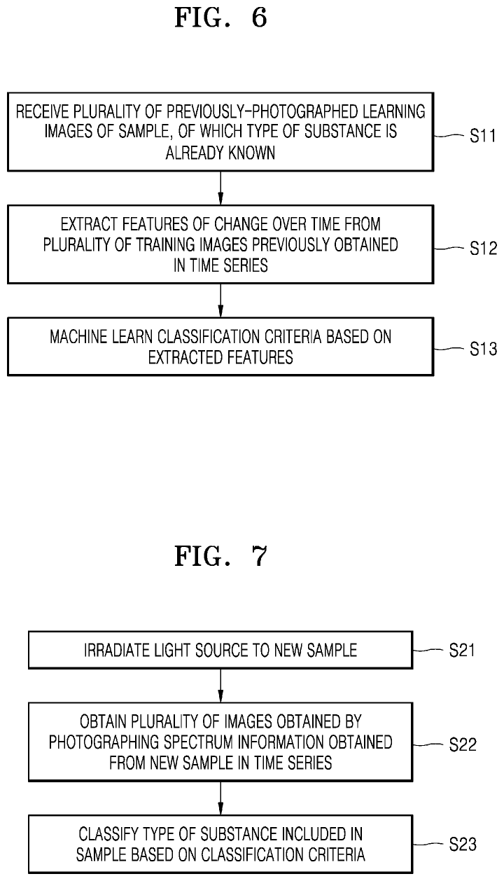

FIGS. 6 and 7 show a method of providing substance information using the substance information providing device according to an embodiment of the present disclosure in time series. In an embodiment, FIG. 6 shows a method of learning classification criteria of the method of providing substance information according to an embodiment of the present disclosure in time series, and FIG. 7 shows a method of determining a substance based on classification criteria of the method of providing substance information according to an embodiment of the present disclosure in a time series.

First, referring to FIG. 6, the substance information providing device 300 according to an example embodiment of the present disclosure may prepare a sample of which type of substance is known in advance, photograph the same, and obtain a plurality of training images (see S11). In the substance information providing device 300, the plurality of training images may be obtained through the receiving unit 310.

Next, the features of change over time are extracted from the plurality of images captured in time series through the detecting unit 322 of the substance information providing device 300 (see S12), and the classification criteria are machine learned based on the extracted features through the learning unit 321 of the substance information providing device 300 (see S13).

The learning unit 321 learns classification criteria based on deep learning, and deep learning is defined as a set of machine learn algorithms that attempt to summarize high-level abstractions (tasks of summarizing key contents or functions in a large amount of data or complex data) through a combination of several nonlinear transducers.

The learning unit 321 is a model of deep learning, for example, deep neural networks (DNN), convolution neural networks (CNN), reccurent neural networks (RNN), and deep belief networks (DBN) may be used.

In an embodiment, the learning unit 321 may machine learn classification criteria based on the temporal correlation of the received plurality of training images.

As described above, as the multiple-light-sources unit 110 sequentially irradiates different wavelengths to the sample unit 120 to measure absorbance and derive the spectrum based on this, the plurality of training images may change over time. The learning unit 321 may learn classification criteria for classifying substances included in the sample by using the change over time of the spectrum as described above.

In an embodiment, the learning unit 321 may machine learn the classification criteria by using spectrum information included in each of the plurality of training images, or may machine learn the classification criteria based on the temporal correlation of the received plurality of training images. In this case, the learning unit 321 may learn classification criteria of substances of the sample by using a spectrum change detected in each of the plurality of training images among the features.

Meanwhile, in FIG. 6, the step of extracting the feature of the change over time from the detecting unit 322 (see S12) and the step of machine learning the classification criteria based on the features extracted from the learning unit 321 (see S13) are shown separately, but the present disclosure is not necessarily limited thereto, and each step may be performed simultaneously without having a predecessor relationship.

FIG. 7 illustrates a method of providing substance information through the substance information providing device 300 according to an embodiment of the present disclosure.

Referring to FIG. 7, a light source is irradiated to a new sample (see S21), and a plurality of images taken in time series of absorbance and spectrum information formed through the sensor unit 200 are obtained (see S22). Thereafter, the type of substance included in the new sample may be classified based on the obtained classification criteria through the determining unit 323 (see S23). An output data obtained through the above-described process may be provided back to the learning unit 321 and used as training data. Through the above method, the spectrometer using multiple light sources according to an embodiment of the present disclosure may detect a substance included in a sample.

The spectrometer using multiple light sources according to an embodiment of the present disclosure described above has the following effects.

The spectrometer using multiple light sources according to an embodiment of the present disclosure may improve sensitivity by using multiple-light-sources unit 110 that irradiates different light sources to sample unit 120 and multiple scatterer 130 that may form a long optical path length.

In an embodiment, the spectrometer using multiple light sources according to an embodiment of the present disclosure may sequentially irradiate light sources having different wavelengths to the sample unit 120, may measure this with the single sensor of the sensor unit 200, may form a long optical path length of the light source through the multiple scatterer 130, and maximize the degree of light absorption, thereby improving the sensitivity of the spectrometer.

In addition, the spectrometer using multiple light sources according to an embodiment of the present disclosure increases the sensitivity of the spectrometer by forming a long optical path length through the multiple scatterer 130, so that the sensitivity of the spectrometer may be improved without a spectrometer including an expensive sensor, and through this, a trace amount of substance present in the sample may be measured.

In addition, the spectrometer using multiple light sources according to an embodiment of the present disclosure may extract features of absorbance and change over time of a spectrum, learn them, and obtain classification criteria for classifying the type of substance, so as to distinguish quickly and accurately the type of substance in the sample.

As described above, the present disclosure has been described with reference to an embodiment shown in the drawings, but this is only exemplary, and those of ordinary skill in the art will understand that various modifications and variations of the embodiments are possible therefrom. Therefore, the true technical protection scope of the present disclosure should be determined by the technical spirit of the appended claims.

1. A spectrometer using multiple light sources, the spectrometer for irradiating a light source to a sample to investigate a sample, the spectrometer comprising:
a sample unit accommodating the sample;
a multiple-light-sources unit configured to irradiate light of different wavelengths to the sample unit;
a sensor unit configured to measure absorbance generated at a wavelength of a light source irradiated to the sample unit; and
a multiple scatterer configured to amplify the number of multiple scattering of the light source irradiated to the sample unit,
wherein the sensor unit derives spectrum information by measuring absorbance at different wavelengths.

2. The spectrometer of claim 1, wherein in regard to a light source irradiated from the multiple-light-sources unit, an optical path length inside the spectrometer is lengthened by the multiple scatterer.

3. The spectrometer of claim 1, wherein the multiple-light-sources unit sequentially irradiates light of different wavelengths to the sample unit.

4. The spectrometer of claim 2, wherein the sensor unit derives spectrum information while measuring absorbance occurring at different wavelengths by using a single sensor.

5. The spectrometer of claim 1, wherein the multiple-light-sources unit comprises a plurality of optical filters capable of passing different wavelengths.

6. The spectrometer of claim 2, wherein the sensor unit
derives spectrum information by measuring absorbance at different wavelengths sequentially irradiated to the sample unit, and
comprises an image sensor obtaining a plurality of images by photographing the spectrum information in time series.

7. The spectrometer of claim 6, further comprising
a substance information providing device configured to provide information on a substance included in a sample using the plurality of images obtained in the in time series, wherein the substance information providing device comprises:
a receiving unit configured to receive the plurality of images;
a detecting unit configured to extract a feature of a change over time from the plurality of images captured in the in time series;
a learning unit configured to machine-learn classification criteria based on the extracted features; and
a determining unit configured to classify substances included in the sample based on the classification criteria.

8. The spectrometer of claim 7, wherein the learning unit learns the classification criteria by using a convolution neural network.

9. The spectrometer of claim 7, wherein the learning unit learns the classification criteria based on a temporal correlation of the plurality of images.
